(19) United States
(12) Patent Application Publication
(10) Pub. No.: US 2015/0126330 A1
(43) Pub. Date: May 7, 2015

(54) POWERTRAIN WITH A CHAIN BREAKAGE DETECTION SYSTEM

(71) Applicant: Caterpillar Paving Products Inc., Brooklyn Park, MN (US)

(72) Inventor: Michael William Ries, Coon Rapids, MN (US)

(73) Assignee: Caterpillar Paving Products Inc., Brooklyn Park, MN (US)

(21) Appl. No.: 14/073,150

(22) Filed: Nov. 6, 2013

(51) Int. Cl. F16H 57/01; F16H 7/06

(52) U.S. Cl. CPC F16H 57/01; F16H 7/06; F16H 2057/018
USPC 477/94

(57) ABSTRACT

A pneumatic compactor includes a power source configured to generate power, a pneumatic tire configured to rotate, a chain drive assembly that couples the power source to the pneumatic tire, a proximity sensor, an indicator, a braker controller, and a controller. The chain drive assembly has a chain case and a chain housed in the chain case. The proximity sensor is coupled to the chain case and configured to detect a breakage of the chain and generate a signal signifying the breakage of the chain. The indicator is configured to indicate the breakage of the chain. The brake controller is configured to stop rotation of the pneumatic tire. The controller is configured to receive the indication from the proximity sensor signifying the breakage of the chain, command the indicator to indicate the breakage of the chain, and command the brake controller to stop rotation of the pneumatic tire.

### TECHNICAL FIELD

The present disclosure relates to pneumatic compactor, more particularly to a powertrain with a chain breakage detection system for the pneumatic compactor.

### BACKGROUND

Compactors are extensively used in the road construction industry for construction and repair of the road surfaces. There are a variety of compactors such as soil compactors, landfill compactors, vibratory compactors, tandem vibratory roller compactors, pneumatic compactors, and the like. The present disclosure is directed to the pneumatic compactors. The pneumatic compactors include a set of pneumatically inflated tires. The operation of the pneumatic compactor is based on the pressure inside the set of pneumatically inflated tires. The set of pneumatically inflated tires may be driven by a powertrain of the pneumatic compactor. The powertrain of a pneumatic compactor generally includes an engine, a transmission, and a chain drive. The chain drive transmits power/motion from the transmission to the set of pneumatically inflated tires of the pneumatic compactor. A typical chain drive may include one or more chains in a chain case. The chains may wear out with time due to excessive use or fatigue loading which may lead to breaking of the one or more chains. The breakage of the one or more chains may damage the powertrain of the pneumatic compactor, among other things.

In instances where the chain drive has multiple chains, a single chain may break while the other chains are in a proper working condition. Therefore, the breakage of the chain may go unnoticed by an operator in such a chain drive.

### SUMMARY OF THE DISCLOSURE

A pneumatic compactor includes a power source configured to generate power, a pneumatic tire configured to rotate, a chain drive assembly that couples the power source to the pneumatic tire, a proximity sensor, an indicator, a braker controller, and a controller. The chain drive assembly has a chain case and a chain housed in the chain case. The proximity sensor is coupled to the chain case and configured to detect a breakage of the chain and generate a signal signifying the breakage of the chain. The indicator is configured to indicate the breakage of the chain. The brake controller is configured to stop rotation of the pneumatic tire. The controller is configured to receive the indication from the proximity sensor signifying the breakage of the chain, command the indicator to indicate the breakage of the chain, and command the brake controller to stop rotation of the pneumatic tire.

### BRIEF DESCRIPTION OF DRAWINGS

FIG. 1 shows an isometric view of an exemplary pneumatic compactor in which the present disclosure can be implemented in accordance with an embodiment;

FIG. 2 is a block diagram of a powertrain in which the present disclosure may be implemented in accordance with an embodiment; and

FIG. 3 and FIG. 4 illustrate a perspective view and top view of a chain drive assembly in which the present disclosure may be implemented in accordance with an embodiment.

### DETAILED DESCRIPTION OF DRAWINGS

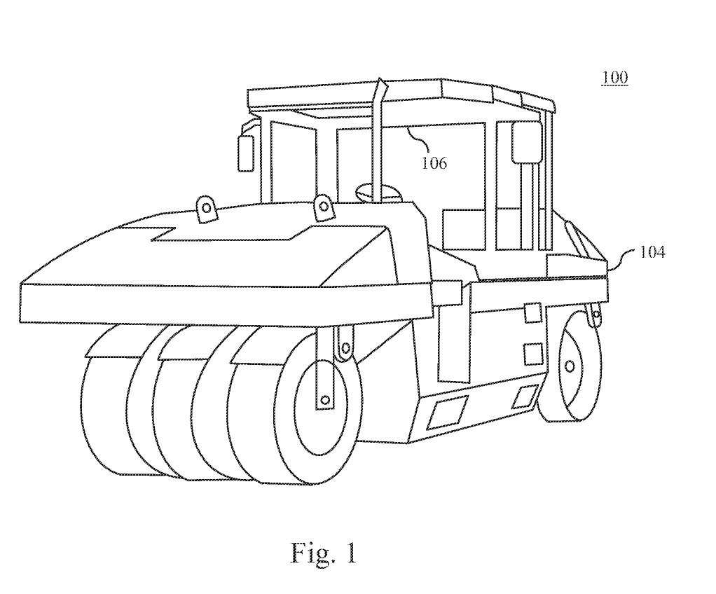

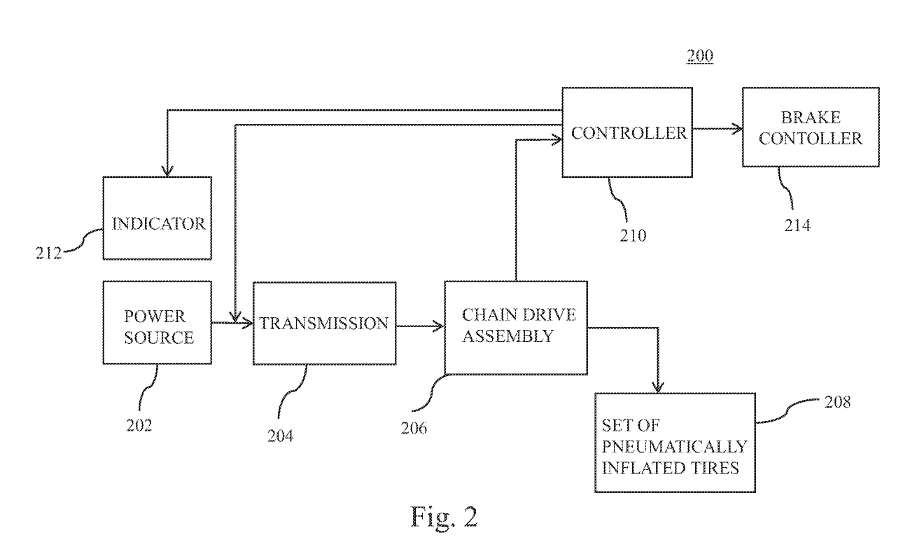

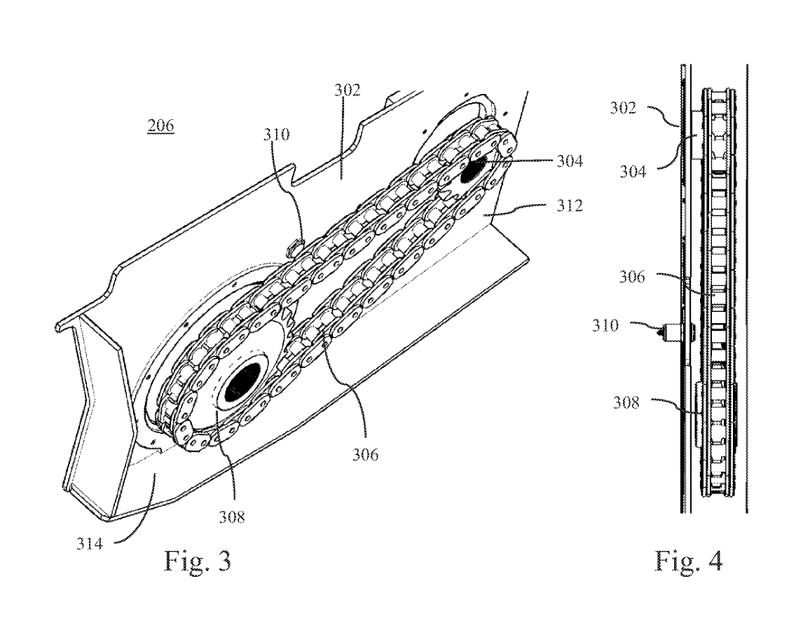

Detailed embodiments of the present disclosure are described herein with reference to FIG. 1, FIG. 2, FIG. 3 and FIG. 4. The specific structural and functional details disclosed herein are intended to be exemplary and should not be interpreted as limiting the disclosure.

FIG. 1 is an isometric view of a pneumatic compactor 100 according to an embodiment of the present disclosure. The pneumatic compactor 100 comprises a mainframe 102, an operator's cab 104 and a powertrain (not shown in figure). The mainframe 102 may be an outer structural frame which may include a plurality of sub structures/sub frames. The mainframe 102 provides an overall structure to the pneumatic compactor 100 and acts as a support to the operator's cab 104. The operator's cab 104 is configured to house various operating controls of the pneumatic compactor 100. The various operating controls include a steering control, a display panel, lever for brake, clutch, accelerator, among other things. The various operating controls are used to control the a powertrain 200.

FIG. 2 is a block diagram of the powertrain 200 according to an embodiment of the present disclosure. The powertrain 200 comprises a power source 202, a transmission 204, a chain drive assembly 206, a set of pneumatically inflated tires 208, a controller 210, an indicator 212, and a brake controller 214.

The power source 202 is configured to generate power. The generated power is used to operate the pneumatic compactor 100. The power source 202 may include but not limiting to an internal combustion engine, an electric drive motor, a hydraulic motor and the like. The power source 202 is functionally coupled to the transmission 204.

The transmission 204 is configured to transfer the power generated by the power source 202 to the chain drive assembly 206. The transmission 204 can be a mechanical transmission or a hydraulic transmission, and the present disclosure is not dependent on any one transmission type. In an embodiment, the transmission 204 may include an input shaft, a set of gears and an output shaft, or the like. The input shaft is configured to functionally couple the transmission 204 to the power source 202. The input shaft is rotatably coupled to the set of gears. The set of gears may be configured to provide multiple selectable gear ratios for power transmission. Thus, enabling the transmission 204 to control the power generated by the power source 202. The set of gears may be functionally coupled to the output shaft. The output shaft may be rotatably coupled to the chain drive assembly 206. The output shaft is configured to transmit a rotatory motion to the set of pneumatically inflated tires 208 via the chain drive assembly 206.

Further, the powertrain 200 includes a controller 210, an indicator 212, and a brake controller 214. The controller 210 is any controller known in the art that is able to receive a signal from a sensor and accordingly generate a command based on the signal received from the sensor.

The indicator 212 can be an alarm device which can indicate a condition. In an embodiment, the indicator 212 can be audio or visual alarm which can be triggered based on the command from the controller 210.

The brake controller 214 can be a traditional brake controller on vehicle and is configured to receive a command from the controller 210 to apply brakes. In other words, the brake controller 214 can communicate and apply brakes as commanded by the controller 210. The functioning of controller 210, the indicator 212 and the brake controller 214 is further described in FIG. 3.

FIG. 3 and FIG. 4 illustrate a perspective view and top view of the chain drive assembly 206, respectively. The chain drive assembly 206 according to an embodiment of the current disclosure may comprise a chain case 302, a first sprocket 304, a chain 306, a second sprocket 308 and a proximity sensor 310.

The chain case 302 may be configured to house various components of the chain drive assembly 206 as described above. In one embodiment, the chain case 302 may house the controller 210 in addition to the first sprocket 304, the chain 306, the second sprocket 308 and the proximity sensor 310. The chain case 302 may have a first end 312 and a second end 314. As illustrated in FIG. 3 and FIG. 4 the chain case 302 houses the first sprocket 304 at the first end 312. The second sprocket 308 is located at the second end 314 of the chain case 302. The first sprocket 304 and the second sprocket 308 are connected by a chain 306. The chain case 302 may further include the proximity sensor 310. The proximity sensor 310 can be mounted at the first end 312 or the second end 314. Hence, the chain case 302 in a manner envelops and may act as a protective cover to protect the first sprocket 304, the chain 306, the second sprocket 308 and the proximity sensor 310 from oil, dirt, and other environmental factors. The chain 306 is any chain known in the art for transferring energy from the first sprocket 304 to the second sprocket 308. In normal operation, the chain 306 is an unbroken loop.

The first sprocket 304 may be rigidly mounted to the output shaft of the transmission 204 such that the first sprocket 304 rotates with the rotation of the output shaft of the transmission 204. The output shaft of the transmission 204 may transfer the rotational motion to the first sprocket 304. The rotational motion of the first sprocket 304 may further be transmitted to the second sprocket 308 via the chain 306. The chain 306 may rotatably pass over the first sprocket 304 and the second sprocket 308. The first sprocket 304 may rotate the chain 306. The chain 306 may in turn, rotate the second sprocket 308. Hence, the first sprocket 304, the chain 306 and the second sprocket 308 along with the proximity sensor 310 forms a chain drive assembly 206. The second sprocket 308 may be rigidly coupled to the set of pneumatically inflated tires 208. The set of pneumatically inflated tires 208 may be configured to replicate the rotational motion of the second sprocket 308 and rotate along with the second sprocket 308.

The chain drive assembly 206 further includes the proximity sensor 310. The proximity sensor 310 is configured to detect the failure of the chain 306. In other words, the proximity sensor 310 can be configured to detect the presence or absence of the chain 306 in proximity and send a signal accordingly. In an embodiment, the proximity sensor 310 can be an optical sensor, a magnetic field sensor, an electromagnetic sensor, an ultrasonic sensor and the like. However, it is evident to a person with ordinary skills in the art that type of the proximity sensor used, nowhere affects the functionality of the present disclosure. The proximity sensor 310 may be mounted in the chain case 302 such that the proximity sensor 310 is in close proximity to the chain 306. In one embodiment, the proximity sensor 310 may be mounted at the first end 312 at the first sprocket 304. However, the mounting location of the proximity sensor 310 in above embodiment is not intended to be limiting. The proximity sensor 310 may be mounted at a suitable location inside the chain case 302 such that the proximity sensor 310 is able to detect a broken chain. The proximity sensor 310 may generate a signal when it detects the breakage or failure of the chain 306. In other words, the proximity sensor 310 can detect the presence or absence of the chain 306 and generate a signal accordingly. The signal generated by the proximity sensor 310 may be monitored by the controller 210.

The controller 210 is configured to monitor the signal generated by the proximity sensor 310. The controller 210 may further perform a series of operations based on a signal generated by the proximity sensor 310. In other words, the controller 210 may receive the signal from the proximity sensor 310 and generate a command to perform a one or more operations. The one or more operations may include controlling the powertrain 200, commanding the brake controller 214 to apply brakes and provide an indication about the fault with the help of the indicator 212. In one embodiment, the controller 210 may command to perform all the three operations. For example, the controller 210 may command the powertrain 200 to slow down and gradually halt, and also command the brake controller 214 to apply brakes. In addition, the controller 210 may simultaneously command the indicator 212 to trigger a visual alarm or an audio visual alarm indicating the breakage of the chain 306. In an embodiment, the pneumatic compactor 100 may have the indicator 212 in the operator's cab 104. The controller 210 may indicate the fault with the help of the indicator 212 in an event of the breakage of the chain 306. The controller 210 may further display information on nature of failure, such as how many chains or which chain has failed.

In operation in an exemplary embodiment, the proximity sensor 310 is mounted in the chain case 302 to detect the breakage of the chain 306 while the chain 306 rotates along with the first sprocket 304 and the second sprocket 308. The chain 306 may break/fail due to wear, excessive loading of the pneumatic compactor 100 or any other reason during the power transmission. The proximity sensor 310 is disposed inside the chain case 302 to determine breakage of the chain 306. In an embodiment, the chain 306 may include magnetic links, which can be sensed by the proximity sensor 310. The proximity sensor 310 may detect a breakage of the chain 306 when one or more magnetic links of the chain 306 are missing. Further, the proximity sensor 310 generates a signal when the breakage of the chain 306 is detected. The controller 210 may be configured to monitor the signal generated by the proximity sensor 310. The controller 210 may command to halt the powertrain 200 and/or command the brake controller 214 to apply the brakes, when the controller 210 senses the signal generated by the proximity sensor 310. The controller 210 may further command the indicator 212 to indicate the operator about the breakage of the chain 306.

### INDUSTRIAL APPLICABILITY

The disclosed chain drive assembly 206 for pneumatic compactor 100 may be used in powertrains of earthmoving and construction equipment such as compactors, scraping machines, conveyors and other similar machines where chain drive can be used for power transmission. In the given embodiments of the disclosure, a proximity sensor 310 is used to detect the breakage of the chain 306 used in the powertrain 200. The proximity sensor 310 is mounted in the chain case 302 to detect the breakage of the chain 306. The proximity sensor 310 generates a signal when the breakage of the chain 306 is detected. The controller 210 is configured to halt the powertrain 200, actuate the brake controller 214 to apply brakes and indicate an operator about the breakage with the help of the indicator 212 when the breakage of the chain 306 is detected by the proximity sensor 310. The operator may replace the chain 306, when it breaks. This may prevent any further damage or wear in the powertrain 200.

The idea of present disclosure is of advantage in industrial applications, earthmoving equipment, and the like. The idea can be used in pneumatic compactors and other earth moving machines where chain breakage is a frequent incident and detection of chain breakage is required for successful and efficient functioning of the machine.

What is claimed is:

1. A pneumatic compactor comprising:
a power source configured to generate power;
a pneumatic tire configured to rotate;
a chain drive assembly that couples the power source to the pneumatic tire; wherein the chain drive assembly comprises:
a chain case having a first end and a second end;
a chain housed in the chain case;
a proximity sensor located coupled to the chain case, wherein the proximity sensor is configured to:
detect a breakage of the chain; and
generate a signal signifying the breakage of the chain;
an indicator configured to indicate the breakage of the chain;
a brake controller configured to stop rotation of the pneumatic tire; and
a controller configured to:
receive the indication from the proximity sensor indicating the breakage of the chain;
command the indicator to indicate the breakage of the chain; and
command the brake controller to stop rotation of the pneumatic tire.
